(19) United States
(12) Patent Application Publication
(10) Pub. No.: US 2013/0228049 A1
(43) Pub. Date: Sep. 5, 2013

(54) REVERSIBLE RATCHET WRENCH

(71) Applicant: APEX TOOL (HK) LIMITED TAIWAN BRANCH, Taichung (TW)

(72) Inventor: Tsung-Hsien SHEN, Taichung (TW)

(73) Assignee: Apex Tool (HK) Limited Taiwan Branch, Taichung (TW)

(21) Appl. No.: 13/782,953

(22) Filed: Mar. 1, 2013

(30) Foreign Application Priority Data
Mar. 2, 2012 (TW) 101107128

(51) Int. Cl. B25B 13/46

(52) U.S. Cl. CPC B25B 13/463
USPC 81/63.1

(57) ABSTRACT

A ratchet wrench includes: a head portion defining a first compartment and a space below; a driving head having an annular driving tooth portion; and first and second detents, each having ratchet teeth to engage the annular driving tooth portion. The first and second detents move laterally between first and second sides of the space simultaneously. When the first and second detents are on the first side, the wrench idle rotates back-pulling along a first direction. When the first and second detents are on the second side, the wrench idle rotates back-pulling along a second direction. Radial alignment diverges between the ratchet teeth of the first detent and the second detent, so that only one of the detents engages the annular driving tooth portion. The other detent is urged against the annular driving tooth portion. When the wrench idle rotates back-pulling, the ratchet teeth of the first and second detents engage with the annular driving tooth portion alternately.

### BACKGROUND OF THE INVENTION

1. Field of the Invention

The present invention relates to a reversible ratchet wrench, and more particularly to a reversible ratchet wrench with a reduced stewing angle required by idle rotation.

2. Description of the Prior Art

In the technical field of hand tools, a ratchet wrench brings great convenience to users. The ratchet wrench provides a function so that in a space where operation is subject to limits, idle rotation back-pulling can be performed without separating the wrench from a fastener thereby improving operational efficiency. The ratchet wrench has developed into a fairly mature technology, allowing developments such as a reversible ratchet wench. In the reversible ratchet wrench, generally a switching member on the wrench is used to adjust an idle rotation back-pulling direction of the wrench, so that the wrench can alternate between two rotation directions without being flipped over, thereby offering more convenience to the user. A large number of patents have been published in the technical field of the ratchet wrench, which is a crowded art. For example, Taiwan Patent No 1350231 discloses a reversible ratchet impact wrench capable of avoiding tooth-breaking, and U.S. Pat. No. 6,918,323B2 provides a reversible ratchet wrench with improved pawls.

However, the reversible ratchet wrench in the prior art still has defects. For example, in an extremely limited operating space, the idle rotation back-pulling angle of the wrench is also extremely limited, such that a relatively small number of ratchet teeth are capable of being skipped by the detent of the wrench during idle rotation back-pulling, thus requiring the user to perform a larger number of rotations before the work is done, thereby limiting working efficiency. In addition, when the user operates a conventional ratchet wrench with a transient large force, the ratchet tooth and the detent may fail to cooperate at the same time to rotate and maintain the relative positional relationship, such that the ratchet tooth and the detent undergo transient relative sliding and loosening, which can damage the wrench or create work hazards. Therefore, it is necessary to provide a ratchet wrench which can improve the working efficiency in an extremely limited operating space and meanwhile ensure that the relative positional relationship between the ratchet tooth aid the detent is kept unchanged in any state of use.

### SUMMARY OF THE INVENTION

One objective of the present invention is to provide a ratchet wrench capable of improving the working efficiency in a limited operating space.

Another objective of the present invention is to provide a ratchet wrench in which the relative positional relationship between the ratchet tooth and the detent is kept unchanged in any state of use.

According to an aspect of the present invention, the present invention provides a ratchet wrench, which includes: a head portion, the head portion defining a first compartment and a space below the first compartment, wherein the space is in communication with the first compartment; a driving head, including an annular driving tooth portion accommodated in the first compartment; and a first detent and a second detent, each having a plurality of ratchet teeth to engage with the annular driving tooth portion, the detents being stacked to be accommodated in the space; wherein through a direction switching button of the wrench, the first detent and the second detent are capable of moving laterally between a first side and a second side of the space simultaneously; wherein when the first detent and the second detest are on the first side of the space, the wrench is capable of undergoing idle rotation back-pulling along a first direction; and when the first detent and the second detent are on the second side of the space, the wrench is capable of undergoing idle rotation back-pulling along a second direction; wherein the radial alignment diverges between the ratchet teeth or the first detent and the ratchet teeth of the second detent, so that only one of the first detent and the second detent is engaged with the annular driving tooth portion, and the other one is urged against the annular driving tooth portion; and wherein when the wrench undergoes the idle rotation back-pulling, the ratchet teeth of the first detent and the ratchet teeth of the second detent are engaged with the annular driving tooth portion alternately.

According to another aspect of the present invention, the internal space provided within the ratchet wrench provided by the present invention further includes a second, compartment accommodating the direction switching button.

According to a further aspect of the present invention, the direction switching button further includes a first lever and a second lever, one end of the levers being accommodated in a recess of the direction switching button through a first elastic member and a second elastic member respectively, and the other end of the levers propping up the first detent and the second detent, respectively.

According to a further aspect of the present invention, an inner wall of the second compartment has a blind hole, a third lever is inserted and accommodated in the blind hole through a third elastic member, and the third lever elastically props up a rear surface of the direction switching button.

The present invention is further illustrated with reference to the accompanying drawings. The accompanying drawings briefly show preferred embodiments according to the present invention. It should be understood that no aspect of the present invention is limited, to the preferred embodiments.

### BRIEF DESCRIPTION OF THE DRAWINGS

FIG. 1 is an exploded view of parts of a reversible ratchet wrench according to the present invention;

FIG. 2 is a partially enlarged view of FIG. 1;

FIG. 3a and FIG. 3b are a three-dimensional structural view and a bottom view of a detent 40, respectively;

FIG. 3c and FIG. 3d are a three-dimensional structural view and a bottom view of a decent 42, respectively;

FIG. 4a and FIG. 4b are schematic structural views of mounted detents, a driving head assembly 20 and a direction switching button 30;

FIG. 5a and FIG. 5b are schematic structural views of a detent engaged with an annular driving tooth portion of a driving head; and

FIG. 6a and FIG. 6b are schematic structural views of a wrench with a direction switching button in a first position and a second position, respectively, according to the present invention.

### DETAILED DESCRIPTION

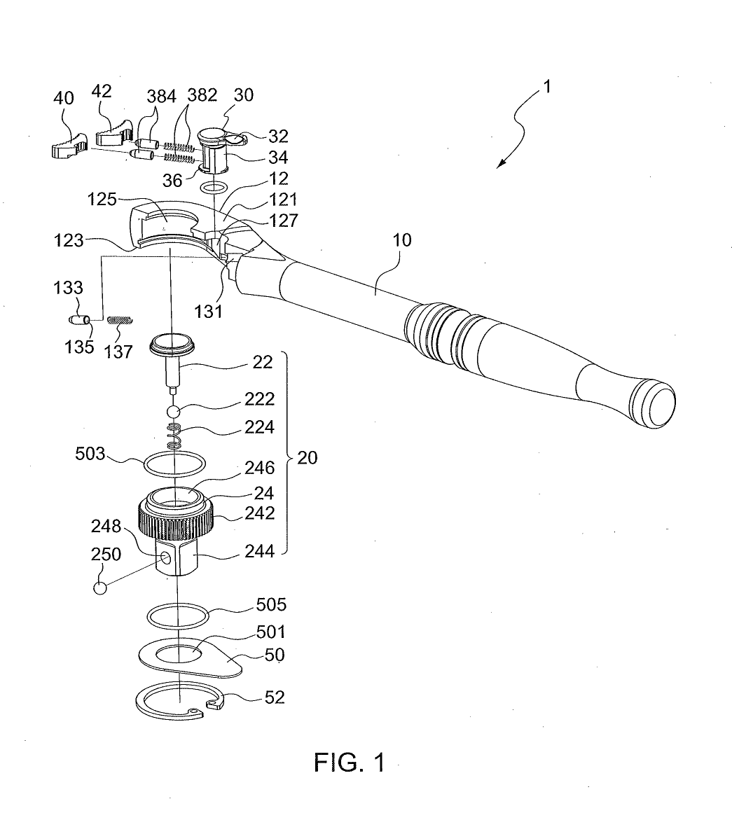

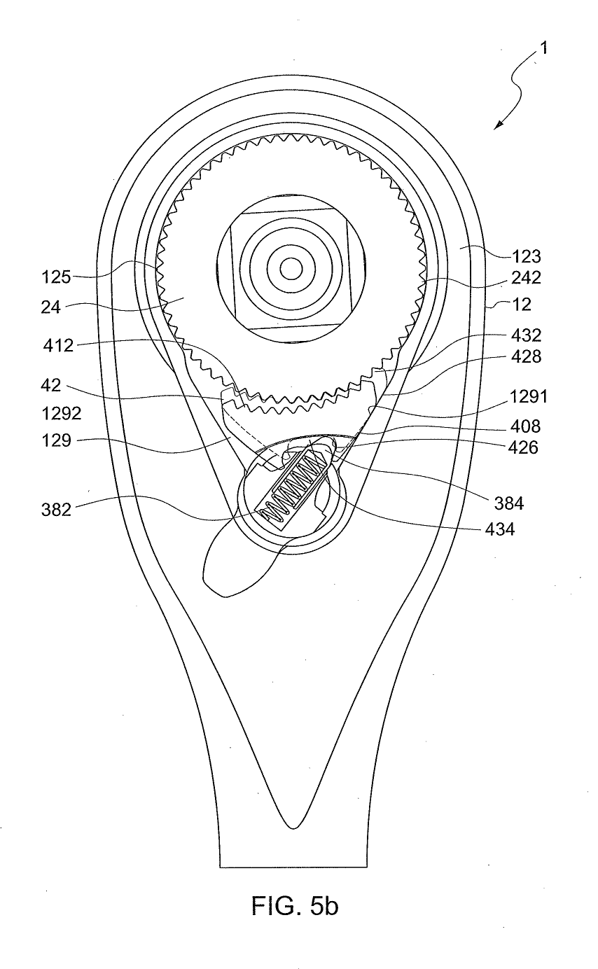

FIG. 1 shows an exploded view of parts of a reversible ratchet wrench 1 according to the present invention. The ratchet wrench 1 has a handle 10 and a head portion 12 connected to one end of the handle 10. For convenience of understanding the structure of the head portion 12, FIG. 1 shows a partial sectional view of the head portion 12. A first compartment 125 and a second compartment 127 through the head portion 12 are defined on a surface 121 of the head portion 12. The first compartment 125 and the second compartment 127 communicate with each other through a middle portion 129 (as shown in FIG. 5a), so that the second compartment 127 and the middle portion 129 together form a space below the first compartment 125. The first compartment 125 the second compartment 127, and the middle portion 129 form a recessed cavity capable of accommodating parts in a surface 123 (as shown in FIG. 5a), opposite to the surface 121, of the head portion 12.

The first compartment 125 is used for accommodating a driving head assembly 20. The driving head assembly 20 includes a press lever 22 and a driving head 24. The driving bead has an annular driving tooth portion 242 and a driving end 244 protruding from the annular driving tooth portion 242. The driving head 24 forms a through hole 246 along an axial direction. The through hole 246 accommodates an elastic member 224, a steel ball 222, and the press lever 22, which are arranged from bottom to top sequentially. A piercing hole 248 in communication with the through hole 246 is formed along a radial direction on a surface of the driving end 244, and is used for accommodating a steel ball 250. Further, the piercing hole 248 is configured to ensure that at most only a portion of the steel ball 250 is exposed out of the surface where the piercing hole 248 is. Therefore, when the press lever 22 is in a non-pressed-down position, the elastic member 224 props up the steel ball 222 to position it in the through hole 246 at a level flush with the steel ball 250 in the piercing hole 248, so that at the moment, the steel ball 222 urges the steel ball 250 against the piercing hole 248, so as to partially expose the steel ball 250 at the surface opening of the driving end 244, and meanwhile, no external force can press the steel ball 250 into the piercing hole 248. When the press lever 22 is pressed down to reach a pressed-down position, the press lever 22 and the steel ball 222 compress the elastic member 224, so that the steel ball 222 leaves its position within the through hole 246 and becomes flush with the piercing hole 248. At this moment, the steel ball 250, under the action of an external force, enters the piercing hole 248, but does not completely fall into the through hole 246 due to being blocked by the press lever 22, and sits only partially within the through hole 246. Therefore, an operator can press the press lever 22 to insert the driving head assembly 20 into a conventional barrel, and then release the press lever 22 to enable the steel ball 250 to be caught in a corresponding recessed cavity in a conventional barrel structure, so as to secure or loosen a fastener.

Naturally, the driving end 244 of the driving head 24 does not have to be the type shown in FIG. 1, and may instead be in the form of any tool head suitable for securing/loosening conventional fasteners, for example, in the form of a hexagon socket sere driver or in the form of a Phillips screwdriver. Alternatively, instead of equipping the driving head 24 with a driving end protruding out of the head portion 12 and members such as the press lever 22 and the steel ball 222, a driving hole can be formed inside the annular driving teeth 242 (that is, the through hole 246), and the driving hole may be in the form of any driving hole of a wrench suitable for securing/loosening conventional fasteners, such as a box wrench.

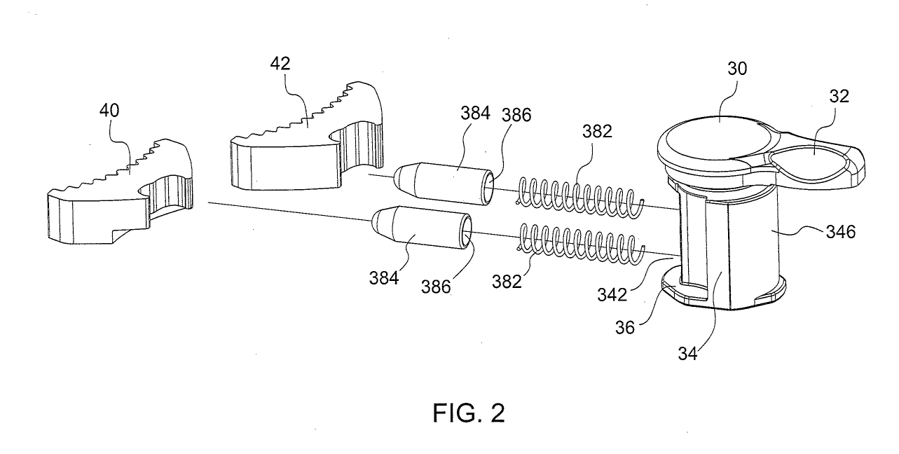

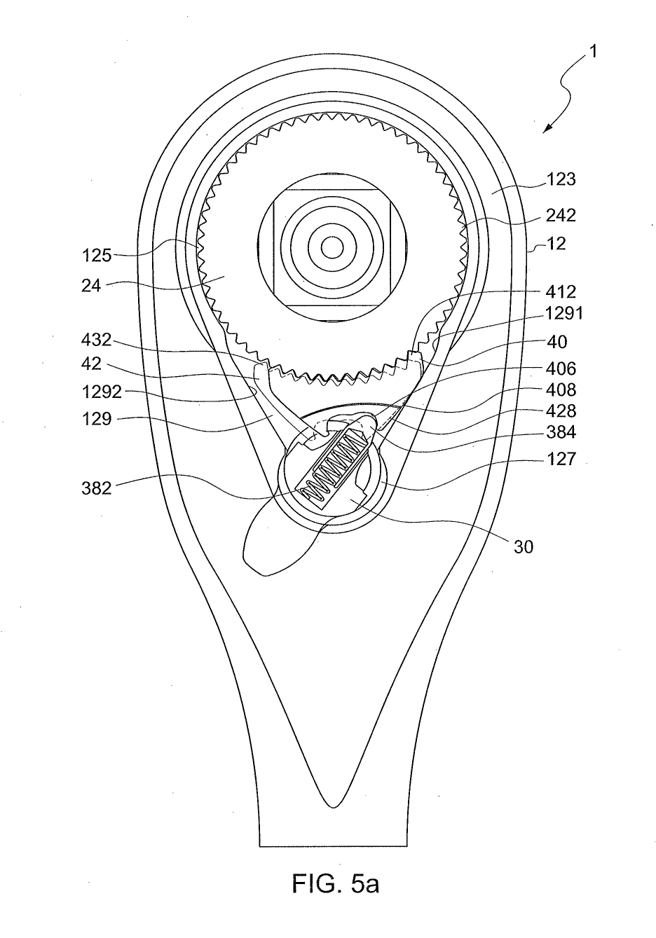

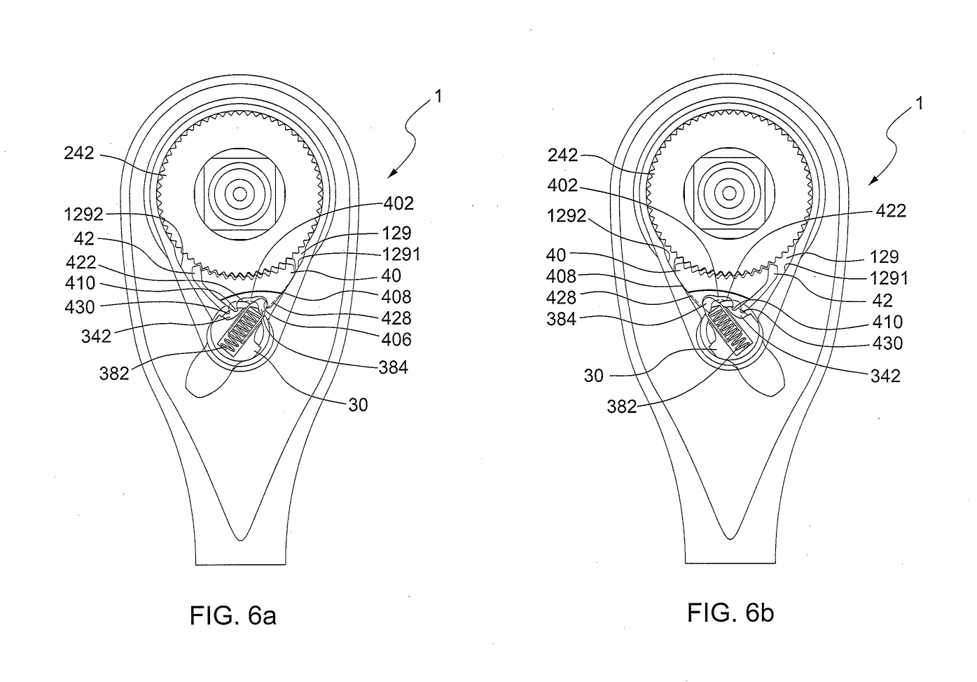

FIG. 2 presents a partially enlarged view of FIG. 1 which shows that a direction switching button 30 includes a top switching lever 32, a middle column 34, and a bottom plate 36. The direction switching button 30 is accommodated in the second compartment 127, and the top switching lever 32, the middle column 34, and the bottom plate 36 may be integrally formed. By pulling the top switching lever 32, the direction switching button 30 can be moved between a first position and a second position shown in FIG. 6a and FIG. 6b, respectively, so as to define a first idle rotation direction and a second idle rotation direction of the wrench. A front side, facing the first compartment 125, of the middle column 34 is recessed inwards relative to the bottom plate 36, so that an inward recessed space 342 exists above a front side of the bottom plate 36. The middle column 34 with the inward recessed front side further has a recess 344 (as shown in FIG. 4b). After elastic members 382 are respectively inserted into receiving slots 386 of levers 384, the vertically stacked levers 384 are inserted and accommodated in the recess 344, so that in an uncompressed state, the elastic members 382 press against a bottom wall of the recess 344, and the levers 384 protrude out of the recess 344. A rear side of the middle column 34 defines a rear surface 346, which may be a curved surface corresponding to the curve of a fall surface of the second compartment 127. A blind hole 131 is formed on an inner side wall surface on one side, close to the handle 10, of the second compartment 127. After an elastic member 137 is inserted into a rear receiving slot 135 of a lever 133, the lever 133 is inserted and accommodated in the blind hole 131. Accordingly, in an uncompressed state, the elastic member 137 presses against a bottom wall of the blind hole 131, and the lever 133 protrudes out of the blind hole 131. When the direction switching button 30 is being mounted in the second compartment 127, the lever 133 needs to be pressed down, so that the rear surface 346 of the middle column 34 of the direction switching button 30 is urged against the lever 133. After the mounting, the lever 133 presses continuously against the rear surface 346 through the elasticity of the elastic member 137, and applies an urging force.

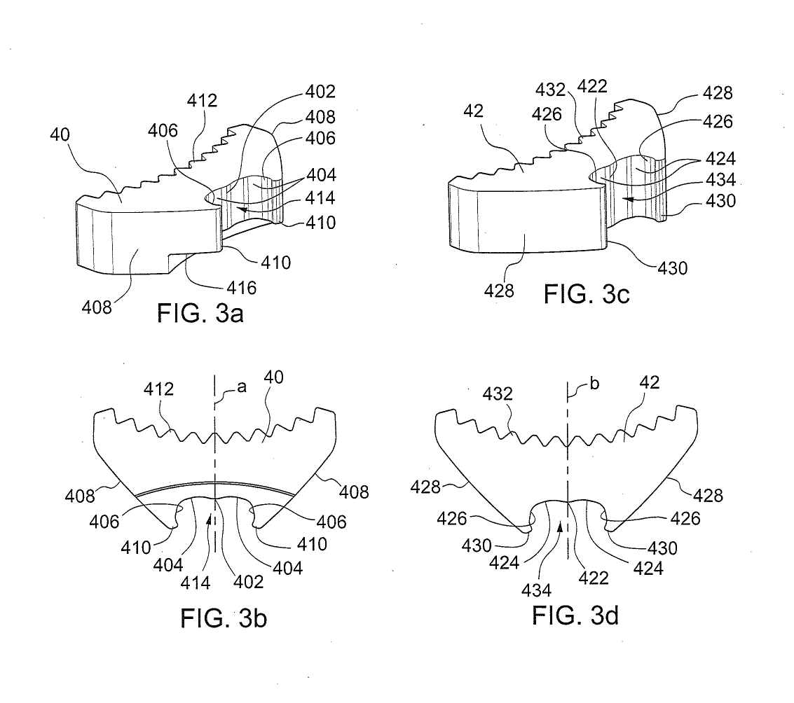

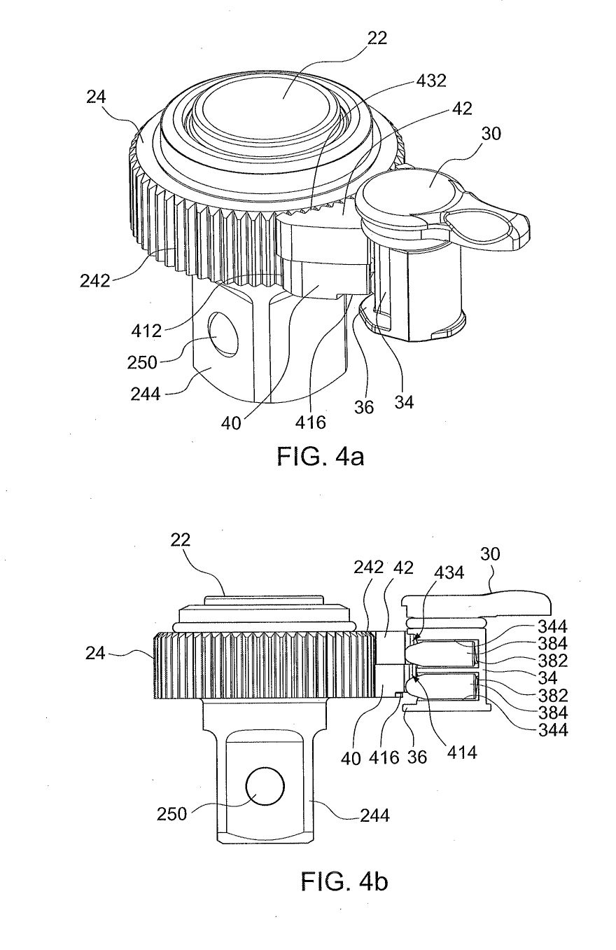

FIG. 3a and FIG. 3b present a three-dimensional structural view and a bottom view of a detent 40, respectively. As shown in the drawings, the detent 40 has a plurality of ratchet teeth 412, which substantially extend towards two lateral sides to form an arc shape capable of defining a radius. The ratchet teeth 412 may continuously cover one complete side of the detent 40, or may only be disposed along a portion of the length of the side. A recessed seat 414 is formed on another side, opposite to the plurality of ratchet teeth 412, of the detent 40. The center of the recessed seat 414 protrudes slightly to form a ridge portion 402, and two lateral portions of the recessed seat 414 may be bilaterally symmetrical with respect to the ridge portion 402, which functions as an axis. The recessed seat 414 extends from the ridge portion 402 to the two lateral sides to sequentially define sliding surfaces 404, propping surfaces 406, and corner portions 410. Two outer side edges of the detent 40 form an urging surface 408, and a bottom of the detent 40 has a cut portion 416.

FIG. 3c and FIG. 3d present a three-dimensional structural view and a bottom view of a detent 42, respectively. As shown in the drawings, the detent 42 has a plurality of ratchet teeth 432, which substantially extend towards two lateral sides to form an arc shape capable of defining a radius. The ratchet teeth 432 may continuously cover one complete side of the detent 42, or may only be disposed along a portion of the length of the side. A recessed seat 434 is formed on another side, opposite to the plurality of ratchet teeth 432, of the detent 42. The center of the recessed seat 434 protrudes slightly to form a ridge portion 422, and two lateral portions of the recessed seat 434 may be bilaterally symmetrical with respect to the ridge portion 422, which functions as an axis. The recessed seat 434 extends from the ridge portion 422 to the two lateral sides to sequentially define sliding surfaces 424, propping surfaces 426, and corner portions 430. Two outer side edges of the detent 42 form an urging surface 428.

The profile of the recessed seat 414 of the detent 40 may be substantially the same as the profile of the recessed sea 434 of the detent 42. However, the ratchet teeth 412 of the detent 40 are aligned radially divergently from the ratchet teeth 432 of the detent 42. For example, the ratchet teeth 412 of the detent 40 have a tooth peak at a central axis a passing through the ridge portion 402, but the ratchet teeth 432 of the detent 42 have a tooth valley at a central axis b passing through the ridge portion 422, so that the arrangement of the ratchet teeth of the two detents has a difference of a half tooth pitch. Further, the lengths which the ratchet teeth of the detent 40 and the detent 42 extend may be the same or different. In other words, the number of ratchet teeth of the two detents are not necessarily the same; and in the detent 40 and the detent 42, the lengths of the extension from the central axes along the arc shapes at the two lateral sides may be different.

According to FIG. 1, the detent 42 is stacked on the detent 40, and is mounted between the annular driving tooth portion 242 of the driving head 24 of the driving head assembly 20 in the first compartment 125 and the middle column 34 of the direction switching button 30 in the second compartment 127. In other words, after being mounted, the detents 40 and 42 are located in the middle portion 129 through which the first compartment 125 and the second compartment 127 communicate. FIG. 4a and FIG. 4b are schematic structural views of mounted detents, the driving head assembly 20 and the direction switching button 30. As shown to the drawings, after the detents 40 and 42 are stacked and mounted at the head portion 12 of the wrench 1, the recessed seats 414 and 434 respectively press the levers 384 of the direction switching button 30, and compress the elastic members 382. Consequently, the elastic members 382 apply an elastic force to the levers 384 so as to make the levers 384 press the recessed seats 414 and 434 towards the first compartment 125, so that the detents 40 and 42 are urged against the annular driving tooth portion 242. At that moment, due to the difference in alignment between the ratchet teeth 412 and the ratchet teeth 432, one set of teeth of the ratchet teeth 412 and the ratchet teeth 432 of the detents 40 and 42 is engaged with the annular driving tooth portion 242, and the other set abuts but is not engaged with the annular driving tooth portion 242. In the state shown in FIG. 4a and FIG. 4b, the ratchet teeth 412 of the detent 40 are engaged with the annular driving tooth portion 242, and the ratchet teeth 432 of the detent 42 abut and are not engaged with the annular driving tooth portion 242. Naturally, the ratchet teeth 432 of the detent 42 are alternatively engaged with the annular driving tooth portion 242, while the ratchet teeth 412 of the detent 40 abut the annular driving tooth portion 242 (as shown in FIG. 5b). In other words, for the wrench of the present invention, at the same time point, either the ratchet teeth of the detent 40 or the ratchet teeth of the detent 42 are engaged with the annular driving tooth portion 242. It should be noted that the out portion 416 of the detent 40 corresponds to the bottom plate 36 of the direction switching button 30 after the detent 40 is mounted, so as to prevent interference between the bottom plate 36 and the detent 40 when the direction switching button 30 moves between the first position and the second position.

Once the detents 40 and 42 are mounted to the head portion 12 of the wrench, the main structure of the wrench 1 is completed. At that moment, a closure plate 50 having an opening 501 is used to cover and close the recessed cavity formed in the surface 123, opposite to the surface 121, of the head portion 12 by the first compartment 125, the second compartment 127, and the middle portion 129 of the head portion 12 of the wrench 1, and the driving end 244 of the driving head assembly 20 passes through the opening 501, and is exposed to the outside. A circlip 52 is further mounted on the closure plate 50, and is urged against a side wall top edge of the first compartment 125, so as to fix the closure plate 50. In order to reduce friction between the driving head 24 and the head portion 12 as well as the closure plate 50, O-rings 503 and 505 may be placed on an upper surface and a lower surface of the driving head 24, respectively.

Due to the (half-tooth) divergence in (radial) alignment between the detents 40 and 42, the ratchet wrench 1 provided by the present invention has the effect of reducing the slewing angle. FIG. 5a and FIG. 5b are schematic structural views of the detent 40 and the detent 42 respectively engaged with the annular driving tooth portion 242 of the driving head 24. In FIG. 5a, the direction switching button 30 is in the first position, the elastic member 382 applies an elastic force to push the lever 384, so as to make the lever 384 prop up the propping surface 406, on the side of the recessed seat 414, of the detent 40, and to make the urging surface 408, on the same side, of the decent 40 be urged against a side wall 1291 of the middle portion 129. At that moment, the ratchet teeth 412 of the detent 40 are engage with the annular driving tooth portion 242. Further, the other elastic member 382 applies an elastic force to the other lever 384, so as to make the lever 384 prop up the propping surface 426, on the side of the recessed seat 434, of the detent 42, and to make the urging surface 428, on the same side, of the detent 42 be also urged against the side wall 1291 of the middle portion 129. However, due to the (half-tooth) divergence in (radial) alignment between the ratchet teeth of the detent 42 and the ratchet teeth of the detent 40, the ratchet teeth 432 of the detent 42 are not engaged with the annular driving tooth portion 242, and the detent 42 and the detent 40 are slightly staggered.

When the ratchet wrench 1 shown in FIG. 5a rotates clockwise, since the urging surface 408 of the detent 40 is urged against the side wall 1291, the ratchet teeth 412 are continuously engaged with the annular driving tooth portion 242, so as to drive the driving end 244 to rotate the fastener. Conversely, when the ratchet wrench 1 rotates counterclockwise, the annular driving tooth portion 242 presses the detents 40 and 42 towards the levers 384, so that the detents 40 and 42 reversely urge against the levers 384 and the elastic members 382, thereby performing idle rotation back-pulling on the ratchet wrench 1.

Similarly, in FIG. 5b, the direction switching button 30 is also in the first position, and the elastic member 382 applies an elastic force to push the lever 384, so as to make the lever 384 prop up the propping surface 426, on the side of the recessed seat 434, of the detent 42, and to make the urging surface 428, on the same side, of the detent 42 be urged against the side wall 1291 of the middle portion 129. At that moment, the ratchet teeth 432 of the detent 42 are engaged with the annular driving tooth portion 242. Further, the other elastic member 382 applies an elastic force to the other lever 384, so as to make the lever 384 prop the propping surface 406, on the side of the recessed seat 414, of the detent 40, and to make the urging surface 408, on the same side, of the detent 40 be also urged against the side wall 1291 of the middle portion 129. However, due to the (half-tooth) divergence in (radial) alignment between the ratchet teeth of the detent 40 and the ratchet teeth of the detent 42, the ratchet teeth 412 of the detent 40 are not engaged with the annular driving tooth portion 242, and the detent 40 and the detent 42 are slightly staggered.

When the ratchet wrench 1 shown in FIG. 5b rotates clockwise, the urging surface 428 of the detent 42 is urged against the side wall 1291, so that the ratchet teeth 432 are continuously engaged with the annular driving tooth, portion 242, so as to drive the fastener to rotate. Conversely, when the ratchet wrench 1 rotates counterclockwise, the annular driving tooth portion 242 presses the detents 40 and 42 towards the levers 384, so that the detents 40 and 42 reversely urge against the levers 384 and the elastic members 382, thereby performing idle rotation back-pulling on the ratchet wrench 1.

It should be noted that in the present invention, the divergence in (radial) alignment between the ratchet teeth of the detent 40 and the ratchet teeth of the detent 42 may be a half tooth pitch. In that case, when the ratchet wrench in FIG. 5a undergoes idle rotation back-pulling for a half tooth pitch, the ratchet teeth 412 of the detent 40 depart from and are no longer engaged with the annular driving tooth portion 242. At that moment, due to the (half-tooth) divergence in (radial) alignment between the ratchet teeth of the detent 40 and the ratchet teeth of the ratchet teeth 42, the ratchet teeth 432 of the detent 42 are engaged with the annular driving tooth portion 242, resulting in the state shown in FIG. 5b. At that moment the fastener can be rotated continuously by the detent 42. In other words, during the idle rotation back-pulling of the wrench, the detent 40 and the detent 42 may engage alternately with the annular driving tooth portion 242 for each half tooth pitch. The advantage of this structure compared with a reversible ratchet wrench only having a single detent lies in effectively reducing the idle rotation back-pulling angle. Specifically, during idle rotation back-pulling of a ratchet wrench having only a single detent, the ratchet wrench needs to be pulled by an angle equivalent to a complete tooth pitch before the detent skips to be engaged with the next tooth of the annular driving tooth portion. However, for the ratchet wrench of the present invention, the ratchet wrench only needs to be back-pulled by an angle equivalent to a half tooth pitch before the detent skips to be engaged with a next tooth of the annular driving tooth portion. For example, when the annular driving tooth portion has a total of 60 teeth, the ratchet wrench having a single detent has to be back-pulled by 6° before a tooth of the annular driving tooth portion can be skipped, but the wrench of the present invention only needs to be back-pulled by 3° before a tooth of the annular driving tooth portion can be skipped. Therefore, the effect of the structure of the present invention is equivalent to the effect of the structure of a wrench having a single detent in which the annular driving tooth portion has 120 teeth. The angle required by the wrench of the present invention for back-pulling and engagement of the annular driving tooth portion is merely half that required by the structure having a single detent, thereby effectively improving operational efficiency. Further, the structure of the present invention reduces the required distance of idle rotation back-pulling, making it particularly suitably to applications involving limited operating space.

FIG. 6a and FIG. 6b present schematic structural views showing the direction switching button 30 in the first position and the second position, respectively, according to the present invention. In FIG. 6a, the direction switching button 30 in the first position pushes the detents 40 and 42 to a first side of a space formed by the middle portion 129 and the second compartment 127, and the ratchet wrench 1 may rotate clockwise to secure the fastener through the detent 40 or 42 that transmits torque, and may rotate counterclockwise to undergo idle rotation back-pulling. In order to change the operational direction of the wrench 1, it is only necessary to pull a direction switching lever 38 to the second position shown in FIG. 6b, so that the detents 40 and 42 in the head portion 12 of the ratchet wrench 1 move laterally to the position shown in FIG. 6b (that is, a second side opposite to the first side of the space formed by the middle portion 129 and the second compartment 127), and the wrench 1 may rotate counterclockwise to secure the fastener through the detent 40 or 42 that transmits torque, and may rotate clockwise to undergo idle rotation back-pulling. Specifically, when the direction switching button 30 is in the first position, the levers 384 prop up the propping surface 406 of the detent 40 and the propping surface 426 of the detent 42 respectively, so that the urging surface 408 on one side of the detent 40 and the urging surface 428 on the same side of the detent 42 prop the inner wall 1291 of the middle portion 129 of the head portion 12. At that moment, the corner portions 410 and 430, opposite to the inner wall 1291 of the detent 40 and the detent 42 are in the inward recessed space 342 of the middle column 34. When the direction switching button 30 is pulled from the first position to the second position, the levers 384 respectively slide from the propping surfaces 406 and 426 on one side of the detent 40 and the detent 42, along wall edges of the recessed seats 414 and 434, through the sliding surfaces 404 and 424, the ridge portions 402 and 422, then the sliding surfaces 404 and 424 on the opposite side of the detent 40 and the detent 42, and to the propping surfaces 406 and 426 on the opposite side (as shown in FIG. 6b). While the levers 384 slide along the recessed seats of the detents, the detents 40 and 42 simultaneously slide laterally from the position shown in FIG. 6a, in the middle portion 129, along the annular driving tooth portion 242, and to the position shown in FIG. 6b, so that finally the urging surfaces 408 and 428 on the other side of the detents 40 and 42 prop up an inner wail 1292, opposite to the inner wall 1291, of the middle portion 129, thereby completing a direction switching action of the ratchet wrench 1. In FIG. 6b, the corner portions 410 and 430, opposite to the inner wall 1292, of the detents 40 and 42 are in the inward recessed space 342 of the middle column 34. Since the ridge portions 402 and 422 of the detents 40 and 42 protrude slightly at the center of the recessed seats 414 and 434, respectively, when the levers 384 slide to the ridge portions 402 and 422, the pulling of the direction switching button 30 encounters slightly greater resistance, thereby providing a clear physical sensation to signal a change of direction. Further, while the direction switching button 30 is moving, the moving ratchet teeth 412 of the detent 40 and ratchet teeth 432 of the detent 42 continue being engaged with or propping the annular driving tooth portion of the driving head 24, so that slipping does not occur.

It should be noted that through the elasticity of the elastic member 137 the lever 133 on an inner side wall surface on the side, close to the handle 10, of the second compartment 127 of the head portion 12 of the wrench 1 props up the rear surface 346 of the middle column 34 in the direction switching button 30 continuously, and applies an urging force thereto, thereby ensuring that the levers 384 of the direction switching button 30 make the detents 40 and 42 engage with or urge against the annular driving tooth portion 242 of the driving head 24, and slipping does not occur either in a still state or during operation. Therefore, the structure of the present invention can prevent slipping occurring to the engagement or propping between the ratchet and the annular driving tooth portion which occurs in the conventional ratchet wrench after a long period of use, during direction switching, or when operated with a transient large force, so as to eliminate the possibility of damaging the ratchet wrench, thereby improving operational safety.

Although the specific embodiments of the present invention are describe above, various modification and improvements can be made by persons skilled in the art without departing from the spirit of the present invention, provided such modifications and improvements fall within the scope defined by the present invention.

We claim:

1. A ratchet wrench, comprising:
a head portion, defining a first compartment and a space below the first compartment, the space being in communication with the first compartment;
a driving head, comprising an annular driving tooth portion accommodated in the first compartment; and
a first detent and a second detent, each having a plurality of ratchet teeth to engage with the annular driving tooth portion, the detents being tacked to be accommodated in the space;
wherein through a direction switching button of the wrench, the first detent and the second detent are capable of moving laterally between a first side and a second side of the space simultaneously;
wherein when the first detent and the second, detest are on the first side of the space, the wrench is capable of undergoing idle rotation hack-pulling along a first direction; and when the first detent and the second detent are on the second side of the space, the wench is capable of undergoing idle rotation back-pulling along a second direction;
wherein the radial alignment diverges between the ratchet teeth of the first detent and the ratchet teeth of the second detent, so that only one of the first detent and the second detent is engaged with the annular driving tooth portion, while the other one is urged against the annular driving tooth portion; and
wherein when the wrench undergoes the idle rotation back-pulling, the ratchet teeth of the first detent and the ratchet teeth of the second detent alternately engage with the annular driving tooth portion alternately.

2. The ratchet wrench according to claim 1, wherein the space further comprises a second compartment accommodating the direction switching button.

3. The ratchet wrench according, to claim 2, wherein the direction switching button further comprises a first lever and a second lever, one end of the levers being accommodated in a recess of the direction switching button through a first elastic member and a second elastic member, respectively, and the other end of the levers propping the first detent and the second detent, respectively.

4. The ratchet wrench according to claim 3, wherein the first detent has a recessed seat, and the recessed seat defines a central ridge portion, two opposite sliding surfaces extending from the central ridge portion, and two opposite propping surfaces extending from the two opposite sliding surfaces.

5. The ratchet wrench according to claim 4, wherein a bottom of the first detent has a cut portion.

6. The ratchet wrench according to claim 3, wherein the second detent has a recessed seat, and the recessed seat defines a central ridge portion, two opposite sliding surfaces extending front the central ridge portion, and opposite propping surfaces extending front the two opposite sliding surfaces.

7. The ratchet wrench according to claim 4, wherein the first lever of the direction switching button props up the recessed seat of the first detent.

8. The ratchet wrench according to claim 6, wherein the second lever of the direction switching button props up the recessed seat of the second detent.

9. The ratchet wrench according to claim 3, wherein an inner wall of the second compartment has, a blind hole, a third lever is inserted and accommodated in the blind hole through a third elastic member, and the third lever elastically props up a rear surface of the direction switching button.

10. The ratchet wrench according to claim 1, wherein the divergence in (radial) alignment between the ratchet teeth of the first detent and the ratchet teeth of the second detent is a half tooth pitch.

11. The ratchet wrench according to claim 2, wherein the divergence in (radial) alignment between the ratchet teeth of the first detent and the'ratchet teeth of the second detent is a half tooth pitch.
